(19) United States
(12) Patent Application Publication
(10) Pub. No.: US 2026/0039650 A1
(43) Pub. Date: Feb. 5, 2026

(54) ACCESS TOKEN VERIFICATION

(71) Applicant: Nokia Technologies Oy, Espoo (FI)

(72) Inventors: Xin WANG, Qingdao (CN); Bruno LANDAIS, Lannion (FR); Anja JERICHOW, Munich (DE); Jani Petteri EKMAN, Espoo (FI); Xin Xin WANG, Qingdao (CN); Han Xiao DU, Qingdao (CN); Horst Thomas BELLING, Munich (DE)

(21) Appl. No.: 18/997,415

(22) PCT Filed: Jul. 21, 2022
(86) PCT No.: PCT/CN2022/107172

§ 371 Date: Jan. 21, 2025

(51) Int. Cl. H04L 9/40

(52) U.S. Cl. CPC H04L 63/083

(57) ABSTRACT

Example embodiments of the present disclosure relate to access token verification. In example embodiments, a method is provided. The method comprises, at a first service communication proxy, receiving, from a second service communication proxy, a first request for a service from a first network function, the first request originating from a second network function and comprising a token to access the first network function, the token comprising a delegation domain list to which token verification is delegated by the first network function, the token being generated by a network repository function based on registration information from the first network function, the registration information comprising at least one of: an indication of whether a delegation of the token verification is allowed or the delegation domain list: alternatively the first service communication proxy may obtain whether a delegation of the token verification is allowed and the delegation domain list from the network repository function and in accordance with a determination that the first service communication proxy belongs to the delegation domain list, verifying the token. In this way, the verification of the access token can be improved.

### FIELD

Example embodiments of the present disclosure generally relate to the field of telecommunication, and in particular, to apparatuses, methods, and computer readable media for access token verification.

### BACKGROUND

The 5G Service-Based Architecture (SBA) has been defined to enable flexible and scalable deployments using virtualization and container technologies and cloud-based processing platforms. In the 5G SBA, services are modeled as network functions (NFs) that communicate with each other using application programming interfaces (APIs).

However, the use of virtualized implementation and cloud processing also puts higher and different requirements on security. For example, the security of token verification of access to NF services needs to be well investigated.

### SUMMARY

In general, example embodiments of the present disclosure provide a solution for access token verification.

In a first aspect, there is provided an apparatus. The apparatus comprises at least one processor; and at least one memory storing instructions that, when executed by the at least one processor, cause the apparatus at least to, at a first service communication proxy, receive, from a second service communication proxy, a first request for a service from a first network function, the first request originating from a second network function and comprising a token to access the first network function, the token comprising a delegation domain list to which token verification is delegated by the first network function, the token being generated by a network repository function based on registration information from the first network function, the registration information comprising at least one of: an indication of whether a delegation of the token verification is allowed or the delegation domain list; and in accordance with a determination that the first service communication proxy belongs to the delegation domain list, verify the token.

In a second aspect, there is provided an apparatus. The apparatus comprises at least one processor; and at least one memory storing instructions that, when executed by the at least one processor, cause the apparatus at least to, at a first service communication proxy, receive, from a second service communication proxy, a first request for a service from a first network function, the first request originating from a second network function and comprising a token to access the first network function; obtain a profile associated with the first network function, the profile comprising at least one of: an indication of whether a delegation of token verification is allowed or a delegation domain list to which the token verification is delegated by the first network function; and in accordance with a determination that the first service communication proxy belongs to the delegation domain list, verify the token.

In a third aspect, there is provided an apparatus. The apparatus comprises at least one processor; and at least one memory storing instructions that, when executed by the at least one processor, cause the apparatus at least to, at a network repository function, receive, from a first network function, registration information comprising at least one of: an indication of whether a delegation of token verification is allowed, or a delegation domain list to which the token verification is delegated by the first network function; receive, from a second service communication proxy, a request for a token to access the first network function; and transmit the token to the second service communication proxy.

In a fourth aspect, there is provided an apparatus. The apparatus comprises at least one processor; and at least one memory storing instructions that, when executed by the at least one processor, cause the apparatus at least to, at a first network function, transmit, to a network repository function, registration information comprising at least one of: an indication of whether a delegation of token verification is allowed or a delegation domain list to which the token verification is delegated by the first network function; and receive, from a first service communication proxy, a second request for a service from a first network function, the second request comprising a token to access the first network function and an indication for a success of verification of the token.

In a fifth aspect, there is provided a method. The method comprises: at a first service communication proxy, receiving, from a second service communication proxy, a first request for a service from a first network function, the first request originating from a second network function and comprising a token to access the first network function, the token comprising a delegation domain list to which token verification is delegated by the first network function, the token being generated by a network repository function based on registration information from the first network function, the registration information comprising at least one of: an indication of whether a delegation of the token verification is allowed or the delegation domain list; and in accordance with a determination that the first service communication proxy belongs to the delegation domain list, verifying the token.

In a sixth aspect, there is provided a method. The method comprises: at a first service communication proxy, receiving, from a second service communication proxy, a first request for a service from a first network function, the first request originating from a second network function and comprising a token to access the first network function; obtaining a profile associated with the first network function, the profile comprising at least one of: an indication of whether a delegation of token verification is allowed or a delegation domain list to which the token verification is delegated by the first network function; and in accordance with a determination that the first service communication proxy belongs to the delegation domain list, verifying the token.

In a seventh aspect, there is provided a method. The method comprises: at a network repository function, receiving, from a first network function, registration information comprising at least one of: an indication of whether a delegation of token verification is allowed, or a delegation domain list to which the token verification is delegated by the first network function; receiving, from a second service communication proxy, a request for a token to access the first network function; and transmitting the token to the second service communication proxy.

In an eighth aspect, there is provided a method. The method comprises: at a first network function, transmitting, to a network repository function, registration information comprising at least one of: an indication of whether a delegation of token verification is allowed or a delegation domain list to which the token verification is delegated by the first network function; and receiving, from a first service communication proxy, a second request for a service from a first network function, the second request comprising a token to access the first network function and an indication for a success of verification of the token.

In a ninth aspect, there is provided an apparatus. The apparatus comprises: means for receiving, at a first service communication proxy, from a second service communication proxy, a first request for a service from a first network function, the first request originating from a second network function and comprising a token to access the first network function, the token comprising a delegation domain list to which token verification is delegated by the first network function, the token being generated by a network repository function based on registration information from the first network function, the registration information comprising at least one of: an indication of whether a delegation of the token verification is allowed or the delegation domain list; and means for in accordance with a determination that the first service communication proxy belongs to the delegation domain list, verifying the token.

In a tenth aspect, there is provided an apparatus. The apparatus comprises: means for receiving, at a first service communication proxy, from a second service communication proxy, a first request for a service from a first network function, the first request originating from a second network function and comprising a token to access the first network function; means for obtaining a profile associated with the first network function, the profile comprising at least one of: an indication of whether a delegation of token verification is allowed or a delegation domain list to which the token verification is delegated by the first network function; and means for in accordance with a determination that the first service communication proxy belongs to the delegation domain list, verifying the token.

In an eleventh aspect, there is provided an apparatus. The apparatus comprises: means for receiving, at a network repository function, from a first network function, registration information comprising at least one of: an indication of whether a delegation of token verification is allowed, or a delegation domain list to which the token verification is delegated by the first network function; means for receiving, from a second service communication proxy, a request for a token to access the first network function; and means for transmitting the token to the second service communication proxy.

In a twelfth aspect, there is provided an apparatus. The apparatus comprises: means for transmitting, at a first network function, to a network repository function, registration information comprising at least one of: an indication of whether a delegation of token verification is allowed or a delegation domain list to which the token verification is delegated by the first network function; and means for receiving, from a first service communication proxy, a second request for a service from a first network function, the second request comprising a token to access the first network function and an indication for a success of verification of the token.

In a thirteenth aspect, there is provided a non-transitory computer readable medium comprising program instructions for causing an apparatus to perform at least the method in the fifth to eighth aspects.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1 illustrates an example of a communication system in which some example embodiments of the present disclosure may be implemented;

FIG. 2 illustrates an example of a process flow for access token verification in accordance with some example embodiments of the present disclosure;

FIG. 3 illustrates an example of another process flow for access token verification in accordance with some other example embodiments of the present disclosure;

FIG. 4 illustrates an example process for access token verification in accordance with some example embodiments of the present disclosure;

FIG. 5 illustrates another example process for access token verification in accordance with some other example embodiments of the present disclosure;

FIG. 6 illustrates a further example process for access token verification in accordance with some further example embodiments of the present disclosure;

FIG. 7 illustrates a flowchart of an example method at a first service communication proxy (SCP) in accordance with some example embodiments of the present disclosure;

FIG. 8 illustrates a flowchart of another example method at a first SCP in accordance with some other example embodiments of the present disclosure;

FIG. 9 illustrates a flowchart of an example method at a network repository function (NRF) in accordance with some example embodiments of the present disclosure;

FIG. 10 illustrates a flowchart of an example method at a first network function (NF) in accordance with some example embodiments of the present disclosure;

FIG. 11 illustrates a simplified block diagram of a device that is suitable for implementing some example embodiments of the present disclosure; and

FIG. 12 illustrates a block diagram of an example of a computer readable medium in accordance with some example embodiments of the present disclosure.

Throughout the drawings, the same or similar reference numerals represent the same or similar elements.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As mentioned above, the use of virtualized implementation and cloud processing puts higher and different requirements on security in the 5G SBA. Currently, there is a support for indirect communication between NFs based on token-based authorization. For example, in an existing technology, a NF delegates its token verification to a service communication proxy (SCP). In this case, if another NF requests a service from the NF, the SCP verifies the access token of the other NF on behalf of the NF, and then the SCP signals the NF of a result of the access token verification. If the result indicates an access of the verification, there is no need for the NF to verify the access token from the other NF and provide the requested service.

However, there are still many uncertainties for the existing token verification. For example, the SCP can't know that it is allowed to verify the access token on behalf of the NF. Besides, at the NF side, there is no way for the NF to determine that the SCP that has verified the token is an SCP authorized to verify the access token on behalf of the NF. Currently, there is no way to avoid that the NF provides the requested service without the token having been validated effectively.

In order to solve at least part of the above problems and other potential problems, solutions on access token verification are proposed.

According to some embodiments of the present disclosure, a first SCP receives, from a second SCP, a first request for a service from a first NF. The first request originates from a second NF and comprises a token to access the first NF. The token comprises a delegation domain list to which token verification is delegated by the first NF. The token is generated by a NRF based on registration information from the first NF, and the registration information comprises at least one of: an indication of whether a delegation of the token verification is allowed or the delegation domain list. Then, in accordance with a determination that the first SCP belongs to the delegation domain list, the first SCP verifies the token on behalf on the first NF.

According to some other embodiments of the present disclosure, a first SCP receives, from a second SCP, a first request for a service from a first NF. The first request originates from a second NF and comprises a token to access the first NF. Then, the first SCP obtains a profile associated with the first NF, the profile comprising at least one of: an indication of whether a delegation of token verification is allowed or a delegation domain list to which the token verification is delegated by the first NF. Further, the first SCP, in accordance with a determination that the first SCP belongs to the delegation domain list, verifies the token on behalf on the first NF.

In this way, the mutual trust between the first SCP and the first NF can be assured. As such, the security of the access token verification can be improved.

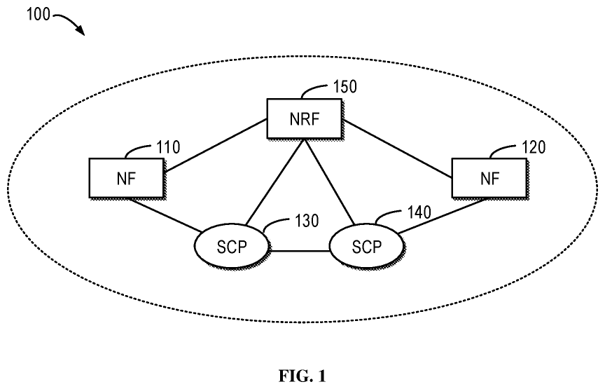

Principle and implementations of the present disclosure will be described in detail below with reference to the accompanying drawings. Reference is now made to FIG. 1.

FIG. 1 illustrates an example of a communication system 100 in which some example embodiments of the present disclosure may be implemented. The environment 100 may be a Public Land Mobile Network (PLMN). As shown in FIG. 1, the environment 100 includes NFs 110 and 120, a SCP 130 serving the NF 110, a SCP 140 serving the NF 120 and a NRF 150 serving one or more of: the NF 110, the NF 120, SCP 130 and SCP 140. In some example embodiments, the NF 110 may act as a service consumer, which may request a service from the NF 120 acting as a service producer. Only for the purpose of illustration, in the following, the NF 120 is also referred to as “NFp 120” or “first NF 120”, and the NF 110 is also referred to as “NFc 110” or “second NF 110”. The SCP 140 connected to the NFp 120 is also referred to as “SCPp 140” or “first SCP 140”, and the SCP 130 connected to the NFc 110 is also referred to as “SCPc 130” or “second SCP 130”.

In FIG. 1, the NRF 150 is a NF which maintains NF profiles and available NF instances. The NRF 150 can also provide service registration and discovery functionalities such that NFs can discover each other. In some example embodiments, with hierarchical (or redundant) NRF setups, the NRF 150 may be different for a request operation for an access token by the SCPc 130 than a NF register operation by the NFp 120 and a NF discover operation by the SCPc 130 delegated for the NFc 110. As an example, the NRF 150 herein may be implemented by an entity that can perform some or all of the above mentioned operations and potential other operations.

In the 5G SBA with Model D (also referred as indirect communication with delegated discovery), the functionalities for discovering and selecting a target NF from a list of available NFs may be delegated to the SCP. In this case, the NFc 110 and the NFp 120 may not directly connect to the NRF 150. As an example, the NFc 110 can discover the target NFp 120 by means of the SCPc 130. However, in the 5G SBA with Model C (also referred as indirect communication without delegated discovery), the SCP may not delegated for target NF discovery. In this case, the NFc 110 may be directly connected to the NRF 150 for target NF discovery and access token request, respectively. For example, the SCPc 130 may be responsible for routing the service request from the NFc 110 to the SCPp 140. It is to be understood that, the SCPs 130 and 140 can be implemented as a same physical network entity or different physical network entities.

In some example embodiments, as shown in FIG. 1, the SCPs 130 and 140 can communicate with the NRF 150 directly. In some other example embodiments, the SCPs 130 or 140 may communicate with the NRF 150 indirectly via one or more other devices or functions.

The communication between the individual devices or functions in the environment 100 may follow any suitable communication standards or protocols, which are already in existence or to be developed in the future. The scope of the present disclosure will not be limited in this regard.

It is to be understood that the devices or functions are shown in the environment 100 only for the purpose of illustration, without suggesting any limitation. The environment 100 may include any other suitable devices, elements or functions for providing communication.

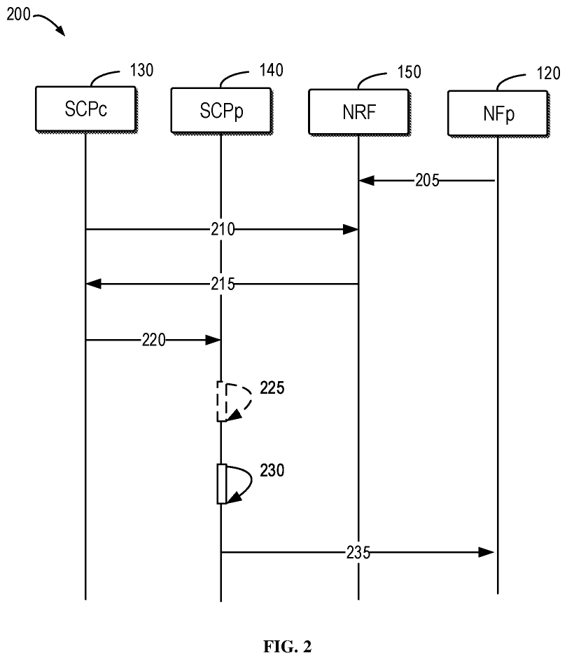

FIG. 2 illustrates an example of a process flow 200 for access token verification in accordance with some example embodiments of the present disclosure. For the purpose of discussion, the process flow 200 will be described with reference to FIG. 1. It would be appreciated that although the process flow 200 has been described in the network environment 100 of FIG. 1, this process flow may be likewise applied to any other similar communication scenarios.

As shown in FIG. 2, the NFp 120 transmits (205) registration information to the NRF 150. For example, the registration information may comprise an indication of whether a delegation of token verification is allowed. Alternatively, or in addition, the registration information may comprise a delegation domain list to which the token verification is delegated by the NFp 120. In this case, for example, if the explicit delegation domain list is absent, a default delegation domain list associated with the domain to which the NFp 120 belongs may be implicitly indicated.

In some example embodiments, when the NFp 120 registers towards the NRF 150, the NFp 120 may add two new attributes “token ValidationDelegationAllowed” and “token ValidationDelegationSCPDomainList” in the NF Profile or the NF Service. For example, the attribute “token ValidationDelegationAllowed” may indicate whether a delegation of token verification is allowed. The attribute “token ValidationDelegationSCPDomainList” may indicate a delegation domain list to which the token verification is delegated by the NFp 120. For example, the NRF 150 may encrypt the “token ValidationDelegationSCPDomainList” in token claims with a configured public key or shared secret.

For example, the NF Profile may be shown in Table 1.

TABLE 1
Definition of type NFProfile

| Attribute | | | | |
|---|---|---|---|---|
| name | Data type | P | Cardinality | Description |
| tokenVali- | Boolean | O | 0 . . . 1 | It indicates whether the NF Service |
| dationDelega- | | | | Producer authorizes the token |
| tionAllowed | | | | validation delegation to the SCPs |
| | | | | within the same SCP domain as the |
| | | | | SCP Domain of the NFp. Absence |
| | | | | of this IE means that the NF Service |
| | | | | Producer has not provided any |
| | | | | indication for token validation |
| | | | | delegation. |
| tokenVali- | array(string) | O | 1 . . . N | It indicates the NF Service Producer |
| dationDelega- | | | | authorizes the token validation |
| tionSCPDomainList | | | | delegation to the SCPs within SCP |
| | | | | domain list. |
| | | | | If this attribute is not present but |
| | | | | “tokenValidationDelegationAllowed” |
| | | | | was included, then by default |
| | | | | NFProfile.scpDomains is used here |
| | | | | implicitly. |

For example, the NF Service may be shown in Table 2.

TABLE 2
Definition of type NFService

| Attribute | | | | |
|---|---|---|---|---|
| name | Data type | P | Cardinality | Description |
| tokenVali- | Boolean | O | 0 . . . 1 | It indicates whether the NF Service |
| dationDelega- | | | | Producer authorizes the token |
| tionAllowed | | | | validation delegation to the SCPs |
| | | | | within the same SCP domain as the |
| | | | | SCP Domain of the NFp. Absence |
| | | | | of this IE means that the NF Service |
| | | | | Producer has not provided any |
| | | | | indication for token validation |
| | | | | delegation. |
| | | | | If this attribute is present, it has |
| | | | | precedence over the value in |
| | | | | NFProfile. |
| tokenVali- | array(string) | O | 1 . . . N | It indicates the NF Service Producer |
| dationDelega- | | | | authorizes the token validation |
| tionSCPDomainList | | | | delegation to the SCPs within SCP |
| | | | | domain list. |
| | | | | If this attribute is not present but |
| | | | | “tokenValidationDelegationAllowed” |
| | | | | is included, then by default |
| | | | | NFProfile.scpDomains is used here |
| | | | | implicitly. |
| | | | | If this attribute is present, it has |
| | | | | precedence over the value in |
| | | | | NFProfile. |

In some example embodiments, these new attributes in the NF profile may be only for use by the NRF 150 or the SCPp 140. For the sake of security, they may not need to be sent to the NFc 110 discovering the NFp 120.

Alternatively, these new attributes may be locally configured in the NRF 150 or in the SCPp 140. In this case, the above registration procedure is not needed.

In some example embodiments, the NFc 110 may transmit to the SCPc 130 a request for a service from the NFp 120. For example, the request may comprise scope information associate with the NFp 120. Then, based on the request, the SCPc 130 may perform discovery procedure with the NRF 150 to find the NFp 120.

Further, as shown in FIG. 2, the SCPc 130 transmits (210) to the NRF 150 a request for a token to access the NFp 120. For example, the NRF 150 generates the token based on the request and the registration information from the NFp 120. Then, the NRF 150 transmits (215) the token to the SCPc 130. For example, the token may comprise a delegation domain list to which token verification is delegated by the NFp 120. In the embodiments where the registration information comprises both the indication of whether a delegation of token verification is allowed, such as, the attribute “token ValidationDelegationAllowed” set to 1, and the delegation domain list to which the token verification is delegated by the NFp 120, such as, the attribute “token ValidationDelegationSCPDomainList”. The token may comprise the “token ValidationDelegationSCPDomainList” as indicated in the registration information. Alternatively, in the embodiments where the registration information comprises only the indication of whether a delegation of token verification is allowed, such as, the attribute “token ValidationDelegationAllowed” set to 1 without the delegation domain list to which the token verification is delegated by the NFp 120, the token may comprise a default delegation domain list implicitly indicated, such as, a delegation domain list associated with the domain to which the NFp 120 belongs.

For example, in this case, the token may be shown in Table 3.

TABLE 3
Definition of type AccessTokenClaims

| Attribute | | | | |
|---|---|---|---|---|
| name | Data type | P | Cardinality | Description |
| tokenVali- | array(string) | O | 1 . . . N | It indicates the NF Service Producer |
| dationDelega- | | | | authorizes the token validation |
| tionSCPDomainList | | | | delegation to the SCP(s) within |
| | | | | SCP domain list. |
| | | | | If this attribute is absent, it indicates |
| | | | | that token validation delegation is |
| | | | | not allowed. |

As shown in FIG. 2, the SCPc 130 transmits (220) a request for the service (also referred to as a first request) from the NFp 120. The first request comprises the token as described above. After reception of the first request, the SCPp 140 may determine whether it belongs to the delegation domain list indicated in the token.

In some example embodiments, the SCPp 140 may determine whether there is a need for the token verification first, and then determine whether it belongs to the delegation domain list indicated in the token. For example, when the service request is received with a token, the SCPp 140 may discover (225) the profile of the NFp 120 to retrieve the oauth2Required, perPlmnOauth2ReqList (as described in 6.1.6.2.3 of Technical Specification (TS) 29.510) to determine whether the token validation is needed and also additional scopes information, such as allowedOperationsPerNfType and allowedOperationsPerNfInstance (as described in 6.1.6.2.3 of TS 29.510) for further token validation. Then, if the token verification is needed, it may then determine whether it belongs to the delegation domain list indicated in the token.

In the example embodiments where the “token ValidationDelegationSCPDomainList” in token claims is encrypted with a configured public key or shared secret, the SCPp 140 may inquire token claims, and deciphers the “token ValidationDelegationSCPDomainList” with the configured public key or shared secret paring with the NRF 150 to check whether it is allowed to validate token. If the SCPp 140 belongs to the delegation domain list, it verifies (230) the token. If the verification is successful, the SCPp 140 transmits (235), to the NFp 120, another request (also referred to as a second request) for the service. For example, the second request may comprise the token and an indication for the success of the verification of the token. For example, an “Authorization Validated” field may be added to the second request to indicate the success of the verification of the token. Otherwise, if the verification is unsuccessful, the SCPp 140 may reject the first request.

Otherwise, if the SCPp 140 does not belong to the delegation domain list, it may relay the token to the NFp 120 directly without the indication for the success of the verification of the token. Then, the NFp 120 may verify the token by itself.

In the embodiments where the second request comprises an indication for the success of the verification of the token, the NFp 120 may further determine whether the SCPp 140 belongs to the delegation domain list. As an example, the NFp 120 may determine the SCP Domain identifier (ID) of the SCPp 140 based on the Transport Layer Security (TLS) Certificate. Then, on this basis, the NFp 120 may determine whether the SCPp 140 belongs to the delegation domain list. For example, the NFp 120 may verify that the SCPp pertains to the default SCP domain list to which the NFp 120 belongs or to a SCP Domain list authorized by the NFp 120.

For example, if the SCPp 140 belongs to the delegation domain list, the NFp 120 may no longer need to validate the access token. The NFp 120 may further verify scope information comprised in the second request. Otherwise, if the SCPp 140 does not belong to the delegation domain list, the NFp 120 may verify the token by itself.

Through the process flow 200, the mutual trust between the SCPp 140 and the NFp 120 can be assured.

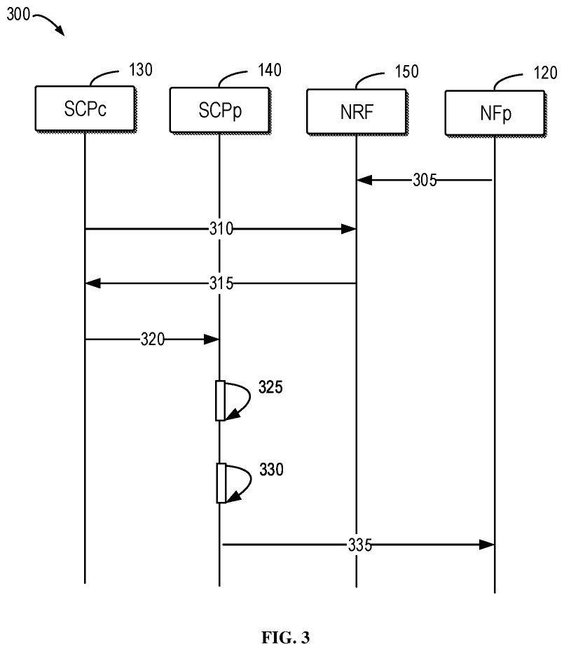

FIG. 3 illustrates an example of another process flow 300 for access token verification in accordance with some other example embodiments of the present disclosure. For the purpose of discussion, the process flow 300 will be described with reference to FIG. 1. It would be appreciated that although the process flow 300 has been described in the network environment 100 of FIG. 1, this process flow may be likewise applied to any other similar communication scenarios.

As shown in FIG. 3, the NFp 120 transmits (305) registration information to the NRF 150. For example, the registration information may comprise an indication of whether a delegation of token verification is allowed. Alternatively, or in addition, the registration information may comprise a delegation domain list to which the token verification is delegated by the NFp 120. Similarly as described with reference to FIG. 2, the indication and the delegation domain list may be implemented as two attributes “token ValidationDelegationAllowed” and “token ValidationDelegationSCPDomainList” in the NF Profile. The related details as described with reference to FIG. 2 are also applicable.

In some example embodiments, the NFc 110 may transmit to the SCPc 130 a request for a service from the NFp 120. For example, the request may comprise scope information associate with the NFp 120. Then, based on the request, the SCPc 130 may perform discovery procedure with the NRF 150 to find the NFp 120.

Further, as shown in FIG. 3, the SCPc 130 transmits (310) to the NRF 150 a request for a token to access the NFp 120. For example, the NRF 150 generates the token based on the request and the registration information from the NFp 120. Then, the NRF 150 transmits (315) the token to the SCPc 130.

Then, the SCPc 130 transmits (320) a request for a service (also referred to as a first request) from the NFp 120. The first request comprises the token. After reception of the first request, the SCPp 140 obtains (325) a profile associated with the NFp 120. For example, the profile may comprise an indication of whether a delegation of token verification is allowed. Alternatively or in addition, the profile may comprise a delegation domain list to which the token verification is delegated by the NFp 120. Similarly as described with reference to FIG. 2, for example, if the explicit delegation domain list is absent, a default delegation domain list associated with the domain to which the NFp 120 belongs may be implicitly indicated.

In some example embodiments, before the reception of the first request, the SCPp 140 may transmit, to the NRF 150, a subscribe request for at least one profile associated with at least one NF in at least one domain, where the at least one NF comprises the NFp 120. Then, the NRF 150 may transmit to the SCPp 140 the at least the profile. For example, the subscribe request may comprise a flag to instruct the NRF 150 to transmit the at least one profile to the SCPp 140 immediately. Then, the NRF 150 may transmit a subscribe response to the SCPp 140. In this case, the SCPp 140 may subscribe changes of the at least one profile associated with at least one NF comprising the NFp 120. On this basis, the SCPp 140 may obtain, from the at least one profile, the profile associated with the NFp 120 based on the first request. Thereby, the SCPp 140 may bind the first request with the profile associated with the NFp 120.

In some example embodiments, after the reception of the first request, the SCPp 140 may determine the NFp 120 based on the first request. In this case, the SCPp 140 may then perform discovery procedure with the NRF 150 to obtain, from the NRF 150, the profile associated with the NFp 120 based on the first request.

Then, the SCPp 140 may determine whether it belongs to the delegation domain list explicitly indicated in the profile or the default delegation domain list implicitly indicated.

As shown in FIG. 3, if the SCPp 140 belongs to the delegation domain list, it verifies (330) the token. In some example embodiments, the SCPp 140 may determine whether there is a need for the token verification first, similarly as described with reference to FIG. 2, and then if the token verification is needed, it may then verify the token. If the verification is successful, the SCPp 140 transmits (335), to the NFp 120, another request (also referred to as a second request) for the service. For example, the second request may comprise the token and an indication for the success of the verification of the token. Otherwise, if the verification is unsuccessful, the SCPp 140 may reject the first request.

Otherwise, if the SCPp 140 does not belong to the delegation domain list, it may relay the token to the NFp 120 directly without the indication for the success of the verification of the token. Then, the NFp 120 may verify the token by itself.

In the embodiments where the second request comprises an indication for the success of the verification of the token, the NFp 120 may further determine whether the SCPp 140 belongs to the delegation domain list, similarly as described with reference to FIG. 2. For example, the NFp 120 may verify that the SCPp pertains to the default domain list implicitly indicated or to an explicit domain list authorized by the NFp 120.

For example, if the SCPp 140 belongs to the delegation domain list, the NFp 120 may no longer need to validate the access token. The NFp 120 may further verify scope information comprised in the second request. Otherwise, if the SCPp 140 does not belong to the delegation domain list, the NFp 120 may verify the token by itself.

Through the process flow 300, the mutual trust between the SCPp 140 and the NFp 120 can be assured.

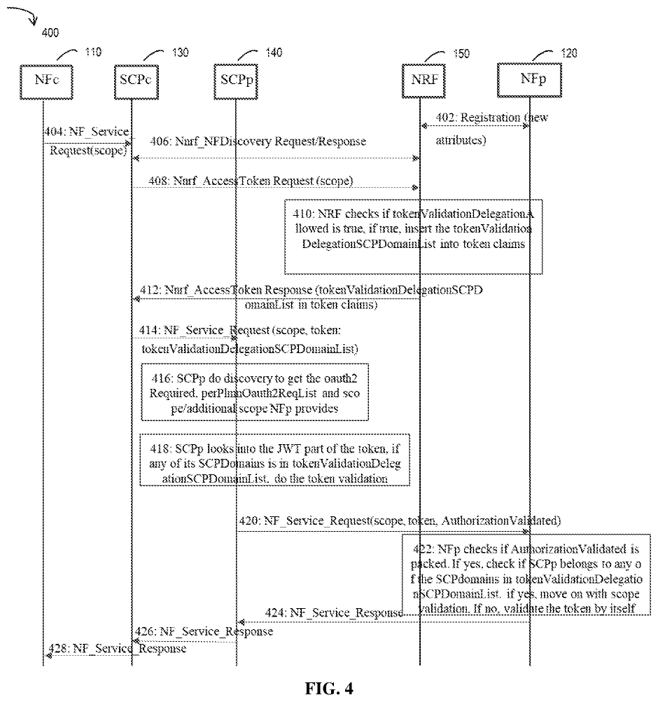

FIG. 4 illustrates an example process 400 for access token verification in accordance with some example embodiments of the present disclosure. For the purpose of discussion, the process 400 will be described with reference to FIG. 1.

As shown in FIG. 4, at 402, the NFp 120 registers the new token delegation attributes in its profile in NRF, such as the “token ValidationDelegationAllowed” to indicate whether a delegation of verification is token allowed, and the “token ValidationDelegationSCPDomainList” to indicate a delegation domain list to which the token verification is delegated by the NFp 120.

At 404, the NFc 110 transmits to the SCPc 130 a service request comprising scope information associated with the NFp 120 that providing the requested service. Then, at 406, the SCPc 130 performs discovery procedure with the NRF 150. For example, with hierarchical NRF setups, the NRF 150 may be implemented as an Authorization Server NRF (AS-NRF).

At 408, the SCPc 130 transmits to the NRF 150 a request for the access token. In some example embodiments, if the SCPc 130 uses “targetNfType” in the request for the access token, the audience in the access token claims may be set accordingly and with multiple matching NF producer instances, “token ValidationDelegationAllowed” and/or “token ValidationDelegationSCPDomainList” may be configured differently. In this case, the NRF 150 may need to act based on the local policy when selecting the results to be included in the granted access token. For example, when implemented as the AS-NRF, the NRF 150 may not have all the NFProfiles for the NF producers checked for the above new parameters. In some other example embodiments, the SCPc 130 use “targetNfInstance” in the request for the access token. In this case, when implemented as the AS-NRF, the NRF 150 may check the associated NFProfile for the above new parameters for access token validation delegation to the SCPp 140 and add the new claims in the access token.

At 410, the NRF 150 checks if “token ValidationDelegationAllowed” is true, and if true, it includes a new claim “token ValidationDelegationSCPDomainList” in the access token to indicate that the token validation can be delegated to SCPs and qualifying the SCPs that are allowed to validate token based on NF Service/NF Profile or alternative local configuration. As an example, when implemented as the AS-NRF, the NRF 150 may need to have local policy used for checking if “token ValidationDelegationAllowed” is true or not. For example, the NRF 150 may encrypt the “token ValidationDelegationSCPDomainList” in token claims with a configured public key or shared secret.

Then, at 412, the NRF 150 responds Nnrf_AccessToken_Get Request with a new token claim “token ValidationDelegationSCPDomainList”. At 414, the SCPc 130 sends to the SCPp 140 a service request with a new token claim “token ValidationDelegationSCPDomainList”. At 416, the SCPp 140 removes any possibly included Authorization Validated header from incoming request. When the service request is received with a token, the SCPp 140 may discover the profile of the NFp 120 to retrieve the oauth2Required, perPlmnOauth2ReqList (as described in 6.1.6.2.3 of Technical Specification (TS) 29.510) to determine whether the token validation is needed and also additional scopes information, such as allowedOperationsPerNfType and allowedOperationsPerNfInstance (as described in 6.1.6.2.3 of TS 29.510) for further token validation. The precondition is that the SCPp 140 is configured with the paired public/secret key of the NRF which is used to validate the token.

Then, at 418, the SCPp 140 inquires token claims, and optionally deciphers the “token ValidationDelegationSCPDomainList” with configured public key or shared secret paring with the NRF 150 to check whether it is allowed to validate token. If so, the SCPp 140 validates the token based on NFProfile retrieved at 416. If the SCPp 140 is not allowed to validate the token, it relays the token to the NFp 120 directly without an Authorization Validated header which is used to indicate that the token verification is successful.

At 420, if token validation is successful, the SCPp 140 forwards to the NFp 120 the NF Service Request with token and the Authorization Validated header indicating that the token has been validated. Otherwise, the SCPp 140 rejects the service request as unauthorized.

At 422, by checking the Authorization Validated header, the NFp 120 is aware of that the token is validated. In this case, the NFp 120 further needs to check whether the SCPp 140 is delegated to perform token validation. For example, the NFp 120 may determine the SCP Domain ID of the SCPp 140 based on the TLS Certificate. Then, on this basis, the NFp 120 may determine whether the SCPp 140 belongs to the delegation domain list. For example, the NFp 120 may verify that the SCPp pertains to the default SCP domain list to which the NFp 120 belongs or to a SCP Domain list authorized by the NFp 120. If the SCPp 140 is delegated for access token validation, the NFp 120 no longer needs to validate the access token, and it only needs to validate that the service request matches the scope(s) indicated in the Hypertext Transfer Protocol (HTTP) scope header. Otherwise, the NFp 120 validates the token by itself. Then, at 424-428, the NF_Service_Response is transmitted to the NFc 110.

All operations and features as described above with reference to FIG. 2 are likewise applicable to the process 400 and have similar effects. For the purpose of simplification, the details will be omitted.

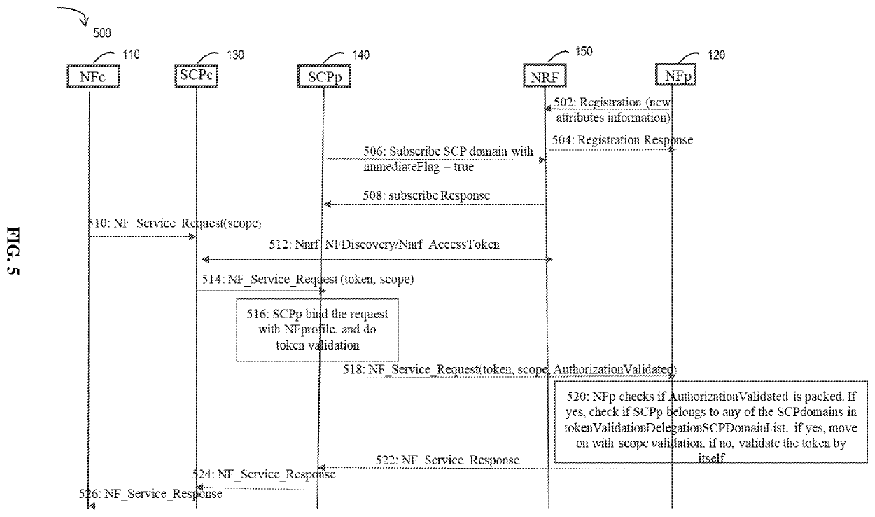

FIG. 5 illustrates another example process for access token verification in accordance with some other example embodiments of the present disclosure. For the purpose of discussion, the process 500 will be described with reference to FIG. 1.

As shown in FIG. 5, at 502, the NFp 120 transmits registration information to the NRF 150. For example, the registration information may comprise an indication of whether a delegation of token verification is allowed and/or a delegation domain list to which the token verification is delegated by the NFp 120. For example, two new attributes “token ValidationDelegationAllowed” and “token ValidationDelegationSCPDomainList” may be comprised in the NF Profile. At 504, the NRF 150 transmits a registration response to the NFp 120.

At 506, the SCPp 140 performs subscription associated with SCP domain to the NRF 150, for example, based on ScpDomainCond. In this case, the SCPp 140 may subscribe to a set of NF, SCP or SEPP instances belonging to certain SCP domains based on ScpDomainCond with immediateFlag set to true to instruct the NRF 150 to transmit the subscribed profiles to the SCPp 140 immediately. At 508, the NRF 150 transmits a subscribe response to the SCPp 140. Then, the SCPp 140 may retrieve the NF services/NF profiles within the requested SCP domains. At 510, the NFc 110 transmits to the SCPc 130 a service request comprising scope information associated with the NFp 120 that providing the requested service. Then, at 512, the SCPc 130 performs discovery procedure with the NRF 150 and obtains the access token from the NRF 150. At 514, the SCPc 130 sends a service request to the SCPp 140.

At 516, after receiving the incoming service request, the SCPp 140 removes any possibly included Authorization Validated header from the incoming request. Then, the SCPp 140 may check the service request and the profile of the NFp 120 to determine whether it is allowed to validate the token, for example, by checking two new attributes: token ValidationDelegationAllowed and token ValidationDelegationSCPDomainList. If allowed and delegated to validate the token, the SCPp 140 validates the token based on the profile of the NFp 120. If the SCPp 140 is not allowed to validate the token, it may transfer the token to the NFp 120 directly without an Authorization Validated header which is used to indicate that the token verification is successful.

At 518, if token validation is successful, the SCPp 140 forwards to the NFp 120 the NF Service Request with token and the Authorization Validated header indicating that the token has been validated. Otherwise, the SCPp 140 rejects the service request as unauthorized.

At 520, by checking the Authorization Validated header, the NFp 120 is aware of that the token is validated. In this case, the NFp 120 further needs to check whether the SCPp 140 is delegated to perform token validation. For example, the NFp 120 may determine the SCP Domain identifier (ID) of the SCPp 140 based on the Transport Layer Security (TLS) Certificate. Then, for example, the NFp 120 may verify that the SCPp pertains to the default SCP domain list to which the NFp 120 belongs or to a SCP Domain list authorized by the NFp 120. If the SCPp 140 is delegated for access token validation, the NFp 120 no longer needs to validate the access token, and it only needs to validate that the service request matches the scope(s) indicated in the Hypertext Transfer Protocol (HTTP) 3gpp-Sbi-Access-Scope header. Otherwise, the NFp 120 validates the token by itself. Then, at 522-526, the NF_Service_Response is transmitted to the NFc 110.

All operations and features as described above with reference to FIG. 3 are likewise applicable to the process 500 and have similar effects. For the purpose of simplification, the details will be omitted.

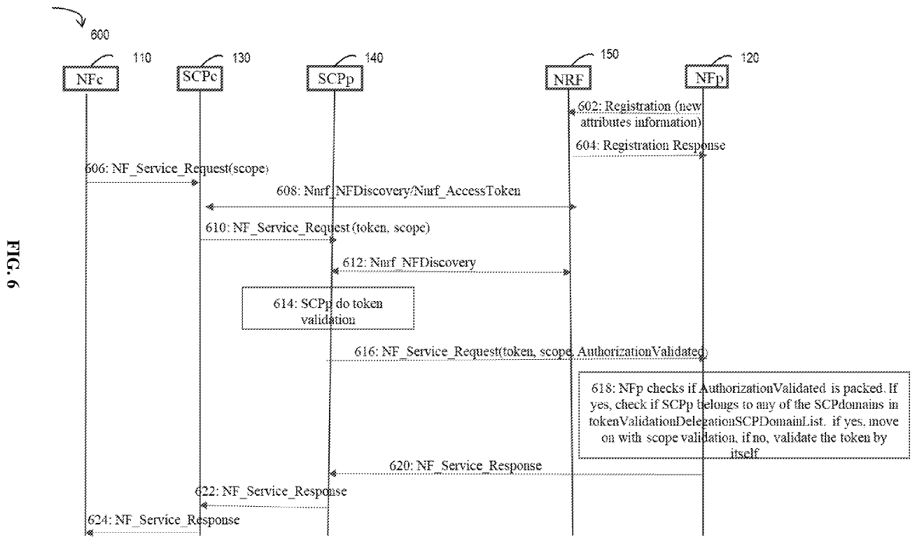

FIG. 6 illustrates a further example process for access token verification in accordance with some further example embodiments of the present disclosure. For the purpose of discussion, the process 400 will be described with reference to FIG. 6.

As shown in FIG. 6, at 602, the NFp 120 transmits registration information to the NRF 150. For example, the registration information may comprise an indication of whether a delegation of token verification is allowed and/or a delegation domain list to which the token verification is delegated by the NFp 120. For example, two new attributes “token ValidationDelegationAllowed” and “token ValidationDelegationSCPDomainList” may be comprised in the NF Profile. At 604, the NRF 150 transmits a registration response to the NFp 120.

At 606, the NFc 110 transmits to the SCPc 130 a service request comprising scope information in the 3gpp-Sbi-Access-Scope header associated with the NFp 120 that providing the requested service. Then, at 608, the SCPc 130 performs discovery procedure with the NRF 150 and obtains the access token from the NRF 150. At 610, the SCPc 130 sends a service request to the SCPp 140. At 612, after receiving the service request, the SCPp 140 performs discovery procedure with the NRF 150 to discover the profile of the NFp 120.

At 614, the SCPp 140 may check the service request and the profile of the NFp 120 to determine whether the token validation is required and if required whether it is allowed to validate the token, for example, by checking two new attributes: token ValidationDelegationAllowed and token ValidationDelegationSCPDomainList. If allowed and delegated to validate the token, the SCPp 140 validates the token based on the profile of the NFp 120. If the SCPp 140 is not allowed to validate the token, it may transfer the token to the NFp 120 directly without an Authorization Validated header which is used to indicate that the token verification is successful.

At 616, if token validation is successful, the SCPp 140 forwards to the NFp 120 the NF Service Request with token and the Authorization Validated header indicating that the token has been validated. Otherwise, the SCPp 140 rejects the service request as unauthorized.

At 618, by checking the Authorization Validated header, the NFp 120 is aware of that the token is validated. In this case, the NFp 120 further needs to check whether the SCPp 140 is delegated to perform token validation. For example, the NFp 120 may determine the SCP Domain identifier (ID) of the SCPp 140 based on the Transport Layer Security (TLS) Certificate. Then, for example, the NFp 120 may verify that the SCPp pertains to the default SCP domain list to which the NFp 120 belongs or to a SCP Domain list authorized by the NFp 120. If the SCPp 140 is delegated for access token validation, the NFp 120 no longer needs to validate the access token, and it only needs to validate that the service request matches the scope(s) indicated in the Hypertext Transfer Protocol (HTTP) 3gpp-Sbi-Access-Scope header. Otherwise, the NFp 120 validates the token by itself. Then, at 620-624, the NF_Service_Response is transmitted to the NFc 110.

All operations and features as described above with reference to FIG. 3 are likewise applicable to the process 600 and have similar effects. For the purpose of simplification, the details will be omitted.

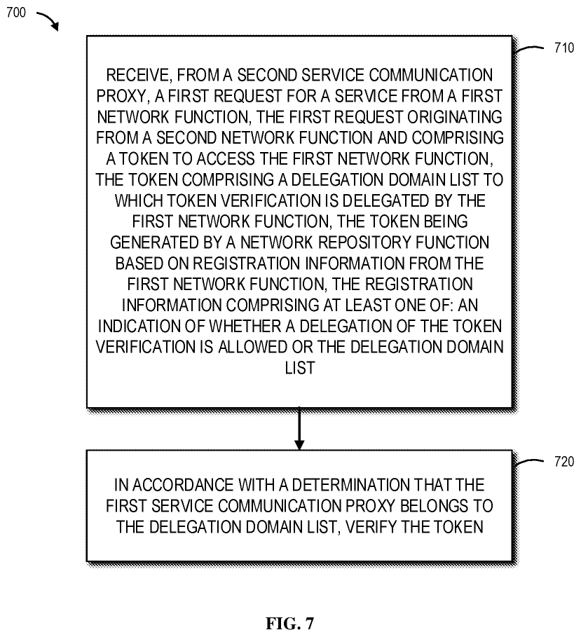

FIG. 7 illustrates a flowchart of an example method 700 at a first SCP in accordance with some example embodiments of the present disclosure. The method 700 can be implemented at any suitable devices. For example, the method 700 may be implemented at the SCPp 140 as described with reference to FIG. 1.

At block 710, the SCPp 140 receives, from the SCPc 130, a first request for a service from a first NF, the first request originating from the NFc 110 and comprising a token to access the first NF, the token comprising a delegation domain list to which token verification is delegated by the NFp 120, the token being generated by the NRF 150 based on registration information from the NFp 120, the registration information comprising at least one of: an indication of whether a delegation of the token verification is allowed or the delegation domain list. At block 720, the SCPp 140, in accordance with a determination that the SCPp 140 belongs to the delegation domain list, verifies the token.

In some example embodiments, the SCPp 140 may in accordance with a determination that there is a need for the token verification, and in accordance with a determination that the SCPp 140 belongs to the delegation domain list, verify the token.

In some example embodiments, the SCPp 140 may, in response to a success of the verification of the token, transmit, to the NFp 120, a second request for the service, the second request comprising the token, and an indication for the success of the verification of the token.

Those skilled in the art can understand that all operations and features as described above with reference to FIG. 2 are likewise applicable to the method 700 and have similar effects.

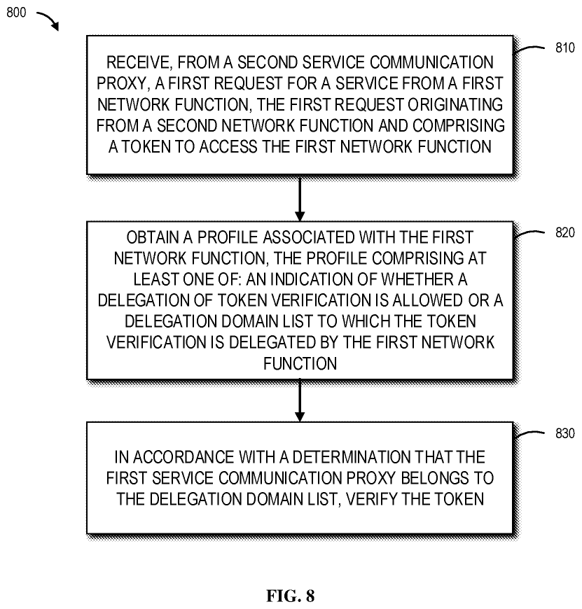

FIG. 8 illustrates a flowchart of another example method 800 at a first SCP in accordance with some other example embodiments of the present disclosure. The method 800 can be implemented at any suitable devices. For example, the method 800 may be implemented at the SCPp 140 as described with reference to FIG. 1.

At block 810, the SCPp 140 receives, from the SCPc 130, a first request for a service from the NFp 120, the first request originating from a NFc 110 and comprising a token to access the NFp 120. At block 820, the SCPp 140 obtains a profile associated with the NFp 120, the profile comprising at least one of: an indication of whether a delegation of token verification is allowed or a delegation domain list to which the token verification is delegated by the NFp 120. At block 830, the SCPp 140, in accordance with a determination that the SCPp 140 belongs to the delegation domain list, verifies the token.

In some example embodiments, the SCPp 140 may transmit, to the NRF 150, a subscribe request for at least one profile associated with at least one NF in at least one domain, the at least one NF comprising the NFp 120, receive the at least the profile from the NRF 150; and obtain, from the at least one profile and based on the first request, the profile associated with the NFp 120.

In some example embodiments, the subscribe request comprises a flag to instruct the NRF 150 to transmit the at least one profile to the SCPp 140.

In some example embodiments, the SCPp 140 may obtain, based on the first request, the profile associated with the NFp 120 from the NRF 150.

In some example embodiments, the SCPp 140 may, in accordance with a determination that there is a need for the token verification, and in accordance with a determination that the SCPp 140 belongs to the delegation domain list, verify the token.

In some example embodiments, the SCPp 140 may, in response to a success of the verification of the token, transmit, to the NFp 120, a second request for the service, the second request comprising the token, and an indication for the success of the verification of the token.

Those skilled in the art can understand that all operations and features as described above with reference to FIG. 3 are likewise applicable to the method 800 and have similar effects.

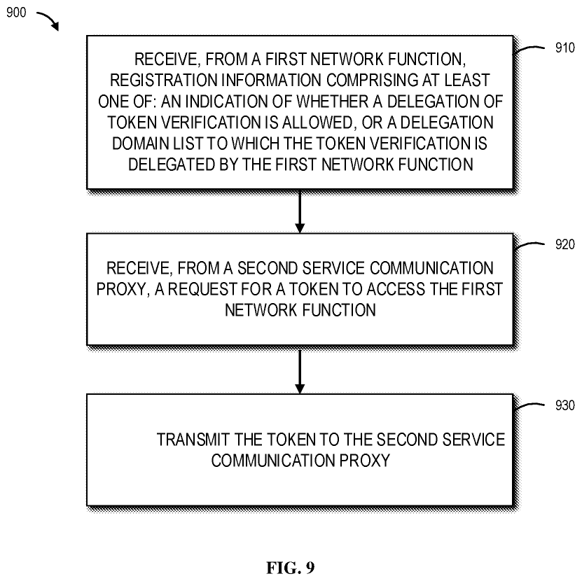

FIG. 9 illustrates a flowchart of an example method 900 at a NRF in accordance with some example embodiments of the present disclosure. The method 900 can be implemented at any suitable devices. For example, the method may be implemented at the NRF 150 as described with reference to FIG. 1.

At block 910, the NRF 150 receives, from the NFp 120, registration information comprising at least one of: an indication of whether a delegation of token verification is allowed, or a delegation domain list to which the token verification is delegated by the NFp 120. At block 920, the NRF 150 receives, from the SCPc 130, a request for a token to access the NFp 120. At block 930, the NRF 150 transmits the token to the SCPc 130.

In some example embodiments, the token comprises the delegation domain list.

In some example embodiments, the NRF 150 may, in response to receiving, from the SCPp 140, a subscribe request for at least one profile associated with at least one NF in at least one domain, transmit the at least one profile to the SCPp 140, the at least one NF comprising the NFp 120 and a profile associated with the NFp 120 in the at least one profile comprising at least one of: the indication or the delegation domain list.

In some example embodiments, the NRF 150 may, in response to receiving, from the SCPp 140, a subscribe request for a profile associated with the NFp 120, transmit the profile to the SCPp 140, the profile comprising at least one of: the indication or the delegation domain list.

Those skilled in the art can understand that all operations and features as described above with reference to FIGS. 3-4 are likewise applicable to the method 900 and have similar effects.

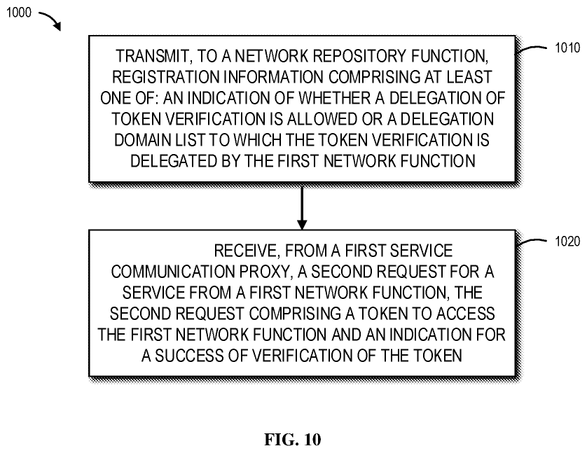

FIG. 10 illustrates a flowchart of an example method 1000 at a first NF in accordance with some example embodiments of the present disclosure. The method 1000 can be implemented at any suitable devices. For example, the method may be implemented at the NFp 120 as described with reference to FIG. 1.

At block 1010, the NFp 120 transmits, to the NRF 150, registration information comprising at least one of: an indication of whether a delegation of token verification is allowed or a delegation domain list to which the token verification is delegated by the NFp 120. At block 1020, the NFp 120 receives, from the SCPp 140, a second request for a service from the NFp 120, the second request comprising a token to access the NFp 120 and an indication for a success of verification of the token.

In some example embodiments, the NFp 120 may, in response to the second request comprising the indication, determine whether the SCPp 140 belongs to the delegation domain list.

In some example embodiments, the NFp 120 may, in accordance with a determination that the SCPp 140 belongs to the delegation domain list, verify scope information comprised in the second request.

In some example embodiments, the NFp 120 may, in accordance with a determination that the SCPp 140 not belonging to the delegation domain list, verify the token.

Those skilled in the art can understand that all operations and features as described above with reference to FIGS. 3-4 are likewise applicable to the method 1000 and have similar effects.

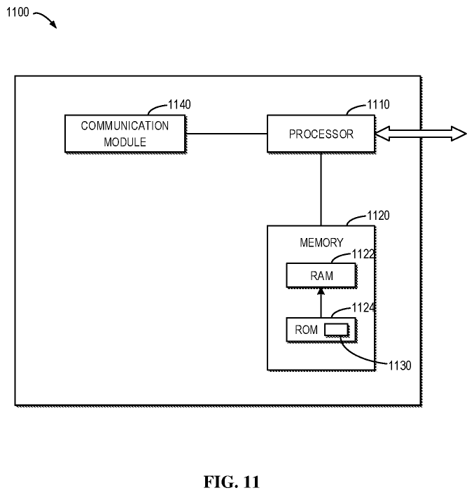

FIG. 11 illustrates a simplified block diagram of a device 1100 that is suitable for implementing some example embodiments of the present disclosure. The device 1100 may be provided to implement the communication device, for example the NFc 110, the NFp 120, the SCPc 130, the SCPp 140 or the NRF 150 as shown in FIG. 1. As shown, the device 1100 includes one or more processors 1110, one or more memories 1120 coupled to the processor 1110, and one or more communication modules 1140 coupled to the processor 1110.

The communication module 1140 is for bidirectional communications. The communication module 1140 has at least one antenna to facilitate communication. The communication interface may represent any interface that is necessary for communication with other network elements.

The processor 1110 may be of any type suitable to the local technical network and may include one or more of the following: general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

The memory 1120 may include one or more non-volatile memories and one or more volatile memories. Examples of the non-volatile memories include, but are not limited to, a Read Only Memory (ROM) 1124, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1122 and other volatile memories that will not last in the power-down duration.

A computer program 1130 includes computer executable instructions that are executed by the associated processor 1110. The program 1130 may be stored in the ROM 1124. The processor 1110 may perform any suitable actions and processing by loading the program 1130 into the RAM 1122.

The embodiments of the present disclosure may be implemented by means of the program 1130 so that the device 1100 may perform any process of the disclosure as discussed with reference to FIGS. 1 to 10. The embodiments of the present disclosure may also be implemented by hardware or by a combination of software and hardware.

In some example embodiments, the program 1130 may be tangibly contained in a computer readable medium which may be included in the device 1100 (such as in the memory 1120) or other storage devices that are accessible by the device 1100. The device 1100 may load the program 1130 from the computer readable medium to the RAM 1122 for execution. The computer readable medium may include any types of tangible non-volatile storage, such as ROM, EPROM, a flash memory, a hard disk, CD, DVD, and the like.

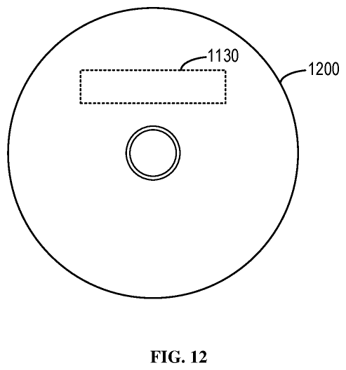

FIG. 12 illustrates a block diagram of an example of a computer readable medium 1200 in accordance with some example embodiments of the present disclosure. The computer readable medium 1200 has the program 1130 stored thereon. It is noted that although the computer readable medium 1200 is depicted in form of CD or DVD in FIG. 12, the computer readable medium 1200 may be in any other form suitable for carry or hold the program 1130.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable medium. The computer program product includes computer-executable instructions, such as those included in program modules, being executed in a device on a target real or virtual processor, to carry out the method 700, 800, 900 or 1000 as described above with reference to FIGS. 7-10. Generally, program modules include routines, programs, libraries, objects, classes, components, data structures, or the like that perform particular tasks or implement particular abstract data types. The functionality of the program modules may be combined or split between program modules as desired in various embodiments.

Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable medium. A computer readable medium may include but not limited to an electronic, magnetic, optical, electromagnetic, infrared, or semiconductor system, apparatus, or device, or any suitable combination of the foregoing. More specific examples of the computer readable medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

Various example embodiments of the techniques have been described. In addition to or as an alternative to the above, the following examples are described. The features described in any of the following examples may be utilized with any of the other examples described herein.

In some aspects, a method comprises: at a first service communication proxy, receiving, from a second service communication proxy, a first request for a service from a first network function, the first request originating from a second network function and comprising a token to access the first network function, the token comprising a delegation domain list to which token verification is delegated by the first network function, the token being generated by a network repository function based on registration information from the first network function, the registration information comprising at least one of: an indication of whether a delegation of the token verification is allowed or the delegation domain list; and in accordance with a determination that the first service communication proxy belongs to the delegation domain list, verifying the token.

In some example embodiments, verifying the token comprises: in accordance with a determination that there is a need for the token verification, and in accordance with a determination that the first service communication proxy belongs to the delegation domain list, verifying the token.

In some example embodiments, the method further comprises: in response to a success of the verification of the token, transmitting, to the first network function, a second request for the service, the second request comprising the token, and an indication for the success of the verification of the token.

In some aspects, a method comprises: at a first service communication proxy, receiving, from a second service communication proxy, a first request for a service from a first network function, the first request originating from a second network function and comprising a token to access the first network function; and obtaining a profile associated with the first network function, the profile comprising at least one of: an indication of whether a delegation of token verification is allowed or a delegation domain list to which the token verification is delegated by the first network function; and in accordance with a determination that the first service communication proxy belongs to the delegation domain list, verifying the token.

In some example embodiments, obtaining the profile associated with the first network function comprises: transmitting, to a network repository function, a subscribe request for at least one profile associated with at least one network function in at least one domain, the at least one network function comprising the first network function; receiving the at least the profile from the network repository function; and obtaining, from the at least one profile and based on the first request, the profile associated with the first network function.

In some example embodiments, the subscribe request comprises a flag to instruct the network repository function to transmit the at least one profile to the first service communication proxy.

In some example embodiments, obtaining the profile associated with the first network function comprises: obtaining, based on the first request, the profile associated with the first network function from a network repository function.

In some example embodiments, verifying the token comprises: in accordance with a determination that there is a need for the token verification, and in accordance with a determination that the first service communication proxy belongs to the delegation domain list, verifying the token.

In some example embodiments, the method further comprises: in response to a success of the verification of the token, transmitting, to the first network function, a second request for the service, the second request comprising the token, and an indication for the success of the verification of the token.

In some aspects, a method comprises: at a network repository function, receiving, from a first network function, registration information comprising at least one of: an indication of whether a delegation of token verification is allowed, or a delegation domain list to which the token verification is delegated by the first network function; receiving, from a second service communication proxy, a request for a token to access the first network function; and transmitting the token to the second service communication proxy. In some example embodiments, the token comprises the delegation domain list.

In some example embodiments, the method further comprises: in response to receiving, from a first service communication proxy, a subscribe request for at least one profile associated with at least one network function in at least one domain, transmitting the at least one profile to the first service communication proxy, the at least one network function comprising the first network function and a profile associated with the first network function in the at least one profile comprising at least one of: the indication or the delegation domain list.

In some example embodiments, the method further comprises: in response to receiving, from a first service communication proxy, a subscribe request for a profile associated with the first network function, transmitting the profile to the first service communication proxy, the profile comprising at least one of: the indication or the delegation domain list.

In some aspects, a method comprises: at a first network function, transmitting, to a network repository function, registration information comprising at least one of: an indication of whether a delegation of token verification is allowed or a delegation domain list to which the token verification is delegated by the first network function; and receiving, from a first service communication proxy, a second request for a service from a first network function, the second request comprising a token to access the first network function and an indication for a success of verification of the token.

In some example embodiments, the method further comprises: in response to the second request comprising the indication, determining whether the first service communication proxy belongs to a domain in the delegation domain list.

In some example embodiments, the method further comprises: in accordance with a determination that the first service communication proxy belongs to the delegation domain list, verifying scope information comprised in the second request.

In some example embodiments, the method further comprises: in accordance with a determination that the first service communication proxy not belonging to the delegation domain list, verifying the token.

In some aspects, an apparatus comprises: at least one processor; and at least one memory storing instructions that, when executed by the at least one processor, cause the apparatus at least to: at a first service communication proxy, receive, from a second service communication proxy, a first request for a service from a first network function, the first request originating from a second network function and comprising a token to access the first network function, the token comprising a delegation domain list to which token verification is delegated by the first network function, the token being generated by a network repository function based on registration information from the first network function, the registration information comprising at least one of: an indication of whether a delegation of the token verification is allowed or the delegation domain list; and in accordance with a determination that the first service communication proxy belongs to the delegation domain list, verify the token.

In some example embodiments, the apparatus is caused to verify the token by: in accordance with a determination that there is a need for the token verification, and in accordance with a determination that the first service communication proxy belongs to the delegation domain list, verifying the token.

In some example embodiments, the apparatus is further caused to: in response to a success of the verification of the token, transmit, to the first network function, a second request for the service, the second request comprising the token, and an indication for the success of the verification of the token.

In some aspects, an apparatus comprises: at least one processor; and at least one memory storing instructions that, when executed by the at least one processor, cause the apparatus at least to: at a first service communication proxy, receive, from a second service communication proxy, a first request for a service from a first network function, the first request originating from a second network function and comprising a token to access the first network function; obtain a profile associated with the first network function, the profile comprising at least one of: an indication of whether a delegation of token verification is allowed or a delegation domain list to which the token verification is delegated by the first network function; and in accordance with a determination that the first service communication proxy belongs to the delegation domain list, verify the token.

In some example embodiments, the apparatus is caused to obtain the profile associated with the first network function by: transmitting, to a network repository function, a subscribe request for at least one profile associated with at least one network function in at least one domain, the at least one network function comprising the first network function; receiving the at least the profile from the network repository function; and obtaining, from the at least one profile and based on the first request, the profile associated with the first network function.

In some example embodiments, the subscribe request comprises a flag to instruct the network repository function to transmit the at least one profile to the first service communication proxy.

In some example embodiments, the apparatus is caused to obtain the profile associated with the first network function by: obtaining, based on the first request, the profile associated with the first network function from a network repository function.

In some example embodiments, the apparatus is caused to verify the token by: in accordance with a determination that there is a need for the token verification, and in accordance with a determination that the first service communication proxy belongs to the delegation domain list, verifying the token.

In some example embodiments, the apparatus is further caused to: in response to a success of the verification of the token, transmit, to the first network function, a second request for the service, the second request comprising the token, and an indication for the success of the verification of the token.

In some aspects, an apparatus comprises: at least one processor; and at least one memory storing instructions that, when executed by the at least one processor, cause the apparatus at least to: at a network repository function, receive, from a first network function, registration information comprising at least one of: an indication of whether a delegation of token verification is allowed, or a delegation domain list to which the token verification is delegated by the first network function; receive, from a second service communication proxy, a request for a token to access the first network function; and transmit the token to the second service communication proxy.

In some example embodiments, the token comprises the delegation domain list.

In some example embodiments, the apparatus is further caused to: in response to receiving, from a first service communication proxy, a subscribe request for at least one profile associated with at least one network function in at least one domain, transmit the at least one profile to the first service communication proxy, the at least one network function comprising the first network function and a profile associated with the first network function in the at least one profile comprising at least one of: the indication or the delegation domain list.

In some example embodiments, the apparatus is further caused to: in response to receiving, from a first service communication proxy, a subscribe request for a profile associated with the first network function, transmit the profile to the first service communication proxy, the profile comprising at least one of: the indication or the delegation domain list.

In some aspects, an apparatus comprises: at least one processor; and at least one memory storing instructions that, when executed by the at least one processor, cause the apparatus at least to: at a first network function, transmit, to a network repository function, registration information comprising at least one of: an indication of whether a delegation of token verification is allowed or a delegation domain list to which the token verification is delegated by the first network function; and receive, from a first service communication proxy, a second request for a service from a first network function, the second request comprising a token to access the first network function and an indication for a success of verification of the token.

In some example embodiments, the apparatus is further caused to: in response to the second request comprising the indication, determine whether the first service communication proxy belongs to the delegation domain list.

In some example embodiments, the apparatus is further caused to: in accordance with a determination that the first service communication proxy belongs to the delegation domain list, verify scope information comprised in the second request.

In some example embodiments, the apparatus is further caused to: in accordance with a determination that the first service communication proxy not belonging to the delegation domain list, verify the token.

In some aspects, an apparatus comprises: means for, receiving, at a first service communication proxy, from a second service communication proxy, a first request for a service from a first network function, the first request originating from a second network function and comprising a token to access the first network function, the token comprising a delegation domain list to which token verification is delegated by the first network function, the token being generated by a network repository function based on registration information from the first network function, the registration information comprising at least one of: an indication of whether a delegation of the token verification is allowed or the delegation domain list; and means for, in accordance with a determination that the first service communication proxy belongs to the delegation domain list, verifying the token.

In some example embodiments, the means for verifying the token comprises:
means for, in accordance with a determination that there is a need for the token verification, and in accordance with a determination that the first service communication proxy belongs to the delegation domain list, verifying the token.

In some example embodiments, the apparatus further comprises: means for in response to a success of the verification of the token, transmitting, to the first network function, a second request for the service, the second request comprising the token, and an indication for the success of the verification of the token.

In some aspects, an apparatus comprises: means for receiving, at a first service communication proxy, from a second service communication proxy, a first request for a service from a first network function, the first request originating from a second network function and comprising a token to access the first network function; and means for obtaining a profile associated with the first network function, the profile comprising at least one of: an indication of whether a delegation of token verification is allowed or a delegation domain list to which the token verification is delegated by the first network function; and means for in accordance with a determination that the first service communication proxy belongs to the delegation domain list, verifying the token.

In some example embodiments, the means for obtaining the profile associated with the first network function comprises: means for transmitting, to a network repository function, a subscribe request for at least one profile associated with at least one network function in at least one domain, the at least one network function comprising the first network function; means for receiving the at least the profile from the network repository function; and means for obtaining, from the at least one profile and based on the first request, the profile associated with the first network function.

In some example embodiments, the subscribe request comprises a flag to instruct the network repository function to transmit the at least one profile to the first service communication proxy.

In some example embodiments, the means for obtaining the profile associated with the first network function comprises: means for obtaining, based on the first request, the profile associated with the first network function from a network repository function.

In some example embodiments, the means for verifying the token comprises: means for in accordance with a determination that there is a need for the token verification, and in accordance with a determination that the first service communication proxy belongs to the delegation domain list, verifying the token.

In some example embodiments, the apparatus further comprises: means for in response to a success of the verification of the token, transmitting, to the first network function, a second request for the service, the second request comprising the token, and an indication for the success of the verification of the token.

In some aspects, an apparatus comprises: means for receiving, at a network repository function, from a first network function, registration information comprising at least one of: an indication of whether a delegation of token verification is allowed, or a delegation domain list to which the token verification is delegated by the first network function; means for receiving, from a second service communication proxy, a request for a token to access the first network function; and means for transmitting the token to the second service communication proxy.

In some example embodiments, the token comprises the delegation domain list.

In some example embodiments, the apparatus further comprises: means for in response to receiving, from a first service communication proxy, a subscribe request for at least one profile associated with at least one network function in at least one domain, transmitting the at least one profile to the first service communication proxy, the at least one network function comprising the first network function and a profile associated with the first network function in the at least one profile comprising at least one of: the indication or the delegation domain list.

In some example embodiments, the method further comprises: in response to receiving, from a first service communication proxy, a subscribe request for a profile associated with the first network function, transmitting the profile to the first service communication proxy, the profile comprising at least one of: the indication or the delegation domain list.

In some aspects, a method comprises: at a first network function, transmitting, to a network repository function, registration information comprising at least one of: an indication of whether a delegation of token verification is allowed or a delegation domain list to which the token verification is delegated by the first network function; and means for receiving, from a first service communication proxy, a second request for a service from a first network function, the second request comprising a token to access the first network function and an indication for a success of verification of the token.

In some example embodiments, the apparatus further comprises: means for in response to the second request comprising the indication, determining whether the first service communication proxy belongs to a domain in the delegation domain list.

In some example embodiments, the apparatus further comprises: means for in accordance with a determination that the first service communication proxy belongs to the delegation domain list, verifying scope information comprised in the second request.

In some example embodiments, the apparatus further comprises: means for in accordance with a determination that the first service communication proxy not belonging to the delegation domain list, verifying the token.

In some aspects, a computer readable medium comprises program instructions stored thereon, the instructions, when executed by a processor of a device, causing the device to perform the method according to some example embodiments of the present disclosure.

1-26. (canceled)

27. An apparatus comprising:
at least one processor; and
at least one memory storing instructions that, when executed by the at least one processor, cause the apparatus at least to:
at a first service communication proxy,
receive, from a second service communication proxy, a first request for a service from a first network function, the first request originating from a second network function and comprising a token to access the first network function, the token comprising a delegation domain list to which token verification is delegated by the first network function, the token being generated by a network repository function based on registration information from the first network function, the registration information comprising at least one of: an indication of whether a delegation of the token verification is allowed or the delegation domain list; and
in accordance with a determination that the first service communication proxy belongs to the delegation domain list, verify the token.

28. The apparatus of claim 27, wherein the apparatus is caused to verify the token by:
in accordance with a determination that there is a need for the token verification, and in accordance with a determination that the first service communication proxy belongs to the delegation domain list, verifying the token.

29. The apparatus of claim 27, wherein the apparatus is further caused to:
in response to a success of the verification of the token, transmit, to the first network function, a second request for the service, the second request comprising the token, and an indication for the success of the verification of the token.

30. An apparatus comprising:
at least one processor; and
at least one memory storing instructions that, when executed by the at least one processor, cause the apparatus at least to:
at a first service communication proxy,
receive, from a second service communication proxy, a first request for a service from a first network function, the first request originating from a second network function and comprising a token to access the first network function;
obtain a profile associated with the first network function, the profile comprising at least one of: an indication of whether a delegation of token verification is allowed or a delegation domain list to which the token verification is delegated by the first network function; and
in accordance with a determination that the first service communication proxy belongs to the delegation domain list, verify the token.

31. The apparatus of claim 30, wherein the apparatus is caused to obtain the profile associated with the first network function by:
transmitting, to a network repository function, a subscribe request for at least one profile associated with at least one network function in at least one domain, the at least one network function comprising the first network function;
receiving the at least the profile from the network repository function; and
obtaining, from the at least one profile and based on the first request, the profile associated with the first network function.

32. The apparatus of claim 31, wherein the subscribe request comprises a flag to instruct the network repository function to transmit the at least one profile to the first service communication proxy.

33. The apparatus of claim 30, wherein the apparatus is caused to obtain the profile associated with the first network function by:
obtaining, based on the first request, the profile associated with the first network function from a network repository function.

34. The apparatus of claim 30, wherein the apparatus is caused to verify the token by:
in accordance with a determination that there is a need for the token verification, and in accordance with a determination that the first service communication proxy belongs to the delegation domain list, verifying the token.

35. The apparatus of claim 30, wherein the apparatus is further caused to:
in response to a success of the verification of the token, transmit, to the first network function, a second request for the service, the second request comprising the token, and an indication for the success of the verification of the token.

36. An apparatus comprising:
at least one processor; and
at least one memory storing instructions that, when executed by the at least one processor, cause the apparatus at least to:
at a network repository function,
receive, from a first network function, registration information comprising at least one of: an indication of whether a delegation of token verification is allowed, or a delegation domain list to which the token verification is delegated by the first network function;
receive, from a second service communication proxy, a request for a token to access the first network function; and
transmit the token to the second service communication proxy.

37. The apparatus of claim 36, wherein the token comprises the delegation domain list.

38. The apparatus of claim 36, wherein the apparatus is further caused to:
in response to receiving, from a first service communication proxy, a subscribe request for at least one profile associated with at least one network function in at least one domain, transmit the at least one profile to the first service communication proxy, the at least one network function comprising the first network function and a profile associated with the first network function in the at least one profile comprising at least one of: the indication or the delegation domain list.

39. The apparatus of claim 36, wherein the apparatus is further caused to:
in response to receiving, from a first service communication proxy, a subscribe request for a profile associated with the first network function, transmit the profile to the first service communication proxy, the profile comprising at least one of: the indication or the delegation domain list.

40. An apparatus comprising:
at least one processor; and
at least one memory storing instructions that, when executed by the at least one processor, cause the apparatus at least to:
at a first network function,
transmit, to a network repository function, registration information comprising at least one of: an indication of whether a delegation of token verification is allowed or a delegation domain list to which the token verification is delegated by the first network function; and
receive, from a first service communication proxy, a second request for a service from a first network function, the second request comprising a token to access the first network function and an indication for a success of verification of the token.

41. The apparatus of claim 40, wherein the apparatus is further caused to:
in response to the second request comprising the indication, determine whether the first service communication proxy belongs to the delegation domain list.

42. The apparatus of claim 41, wherein the apparatus is further caused to:
in accordance with a determination that the first service communication proxy belongs to the delegation domain list, verify scope information comprised in the second request.

43. The apparatus of claim 41, wherein the apparatus is further caused to:
in accordance with a determination that the first service communication proxy not belonging to the delegation domain list, verify the token.
